(19) United States
(12) Patent Application Publication
(10) Pub. No.: US 2025/0303490 A1
(43) Pub. Date: Oct. 2, 2025

(54) METHOD AND SYSTEM FOR PROTECTING A ROBOT SYSTEM FROM A COLLISION

(71) Applicant: FCA US LLC, Auburn Hills, MI (US)

(72) Inventors: Zhohong Fu, Shanghai (CN); Junjie Zhou, Shanghai (CN); Haifeng Guo, Shanghai (CN); Xiaozhou Jiang, Shanghai (CN); Hongyu Wang, Shanghai (CN)

(21) Appl. No.: 18/624,526

(22) Filed: Apr. 2, 2024

(51) Int. Cl. B23K 11/25; B23K 37/00

(52) U.S. Cl. CPC B23K 11/257; B23K 37/006

(57) ABSTRACT

A collision detection circuit for a robotic member and method of operating the same includes an electrically conductive sleeve disposed around the robotic member, a current generating system coupled to a first end of the sleeve and a second end of the sleeve generating a current between the first end and the second end, and a collision controller detecting a change in the current and stopping movement of the robotic member based on detecting the change.

### FIELD

The present disclosure relates to robots and, more particularly, to a collision protection system for a robot system.

### BACKGROUND

This section provides background information related to the present disclosure which is not necessarily prior art.

Robotic systems are used in many manufacturing environments. Some robots are used in a welding environment. Robotic welding systems have a welding arm that moves during the welding process. Typically, movement is in a predetermined path with no impediments to movement. However, there are variables such as human presence, an out of position robot due to mis-programming, sensor failure, faulty components of the robot, faulty components of the holding structure that may cause undesirable contact with the robot.

Existing solutions to prevent damage to the robot include monitoring the torque and power consumption using a motor sensor. Because this type of monitoring is slow to determine, some robot parts may be damaged and need to be replaced. Also, the workpiece may be damaged and also may need to be replaced.

Therefore, preventing damage from contact by the robot and its components such as a welding head is important.

### SUMMARY

This section provides a general summary of the disclosure and is not a comprehensive disclosure of its full scope or all of its features.

In one aspect of the disclosure, a collision detection circuit for a robotic member includes an electrically conductive sleeve disposed around the robotic member, a current generating system coupled to a first end of the sleeve and a second end of the sleeve generating a current between the first end and the second end, and a collision controller detecting a change in the current and stopping movement of the robotic member based on detecting the change.

In another aspect of the disclosure, a method of collision detection circuit for a robotic member includes generating current through a conductive sleeve disposed around the robotic member. The current travels between a first end of the sleeve and a second end of the sleeve. The method further includes detecting a change in the current at a collision controller and stopping movement of the robotic member based on detecting the change.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a welding system according to a present disclosure.

FIG. 2A is a collision monitoring and control unit for the welding system.

FIG. 2B is a plot of current versus time showing a collision.

FIG. 3 is a flowchart of a method for operating the collision monitoring and control unit.

Corresponding reference numerals indicate corresponding parts throughout the several views of the drawings.

### DETAILED DESCRIPTION

Example embodiments will now be described more fully with reference to the accompanying drawings.

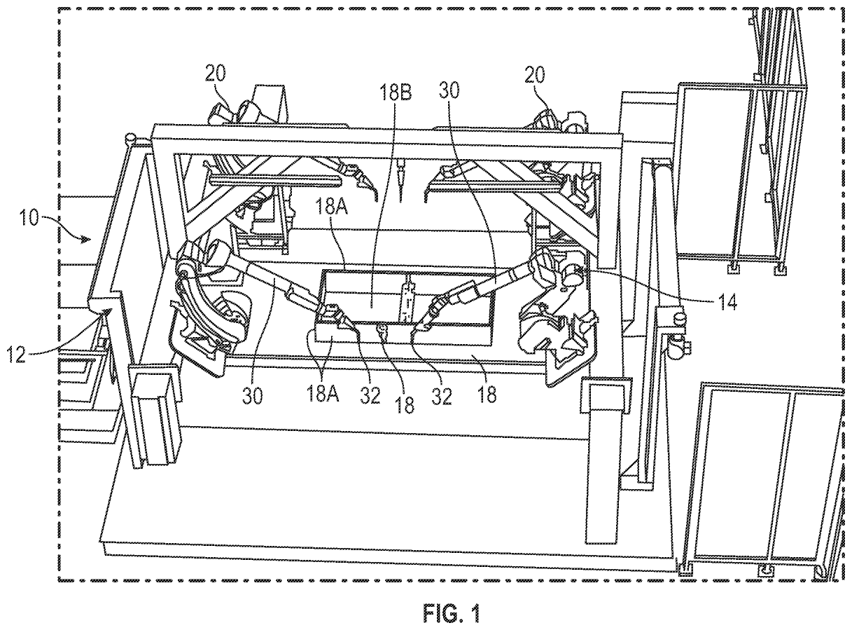

Referring now to FIG. 1, a welding station 10 is illustrated having a machine frame 12 that houses one or a plurality of welding robots 14. The present description is provided relative to a welding system. However, the present system may be used with other welding systems. The welding robots 14, in this example, are shown relative to a fixture 16 that holds a battery tray 18. The welding robots 14 are used to weld the sides 18A and the bottom 18B of the battery tray 18. Other welding robots 20 may be used to weld different positions of the part. The battery tray 18 is loaded into the fixture by an external handling robot which is not shown here.

The welding robots 14 have a robotic members such as robotic arms 30 that move and articulate into the desired positions to perform the welding process. That is, the arm 30 has an arc welding torch 32 disposed at an end thereof.

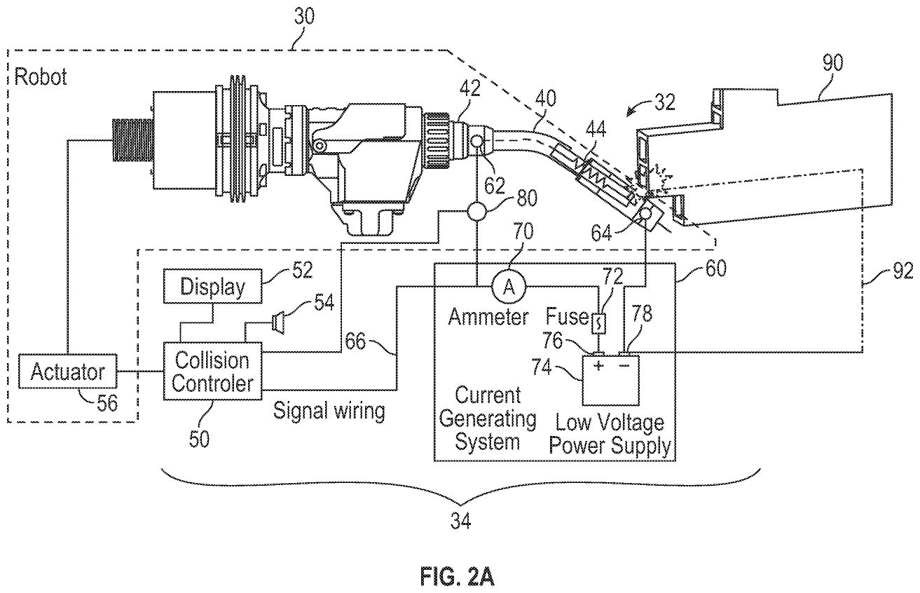

Referring now also to FIG. 2A, the torch 32 is protected from damage by a collision detection circuit 34. An end of a robotic arm 30 is illustrated in FIG. 2A as the robotic member. The robot arm 30 has the torch 32 disposed at an end thereof. The torch 32 extends from the arm 30 and is angular relative to the longitudinal direction of the arm 30 as shown. In this example, the torch 32 is covered by an electrically conductive sleeve 40. That is, the sleeve 40 is coaxial with the torch 32 that is received therein. The sleeve 40 is coupled to the arm 30 at an insulator 42 so that the conductive sleeve 40 is electrically isolated from the arm 30. The sleeve 40 is also electrically isolated from the torch 32. The sleeve 40 has a resistance indicated by the resistor 44. The resistor 44 represents the resistance of the sleeve 40 and may not be a separate component. In other examples, a discrete resistor 44 is coupled to the sleeve 40 possibly across a small gap to provide the desired resistance between the ends of the sleeve 40.

The collision detection circuit 34 includes a collision controller 50 that is a microprocessor-based control unit used to monitor the current through the sleeve 40. The collision controller 50 has a display 52 associated therewith. The display 52 is one or more of a light indicator such a warning light or a screen display such as a computer screen. The display 52, in one example, generates a green light or red light based upon the current or the change in current through the sleeve 40. A red light indicates that a collision has happened. In addition, or instead of the display 52, an audible indicator is generated through a speaker 54. The speaker 54 is loud enough so that workers nearby are alerted and able to take action. The collision controller 50 is also in communication with a robotic actuator 56. The actuator 56 is used to control the movement of the robotic arm 30. The collision controller 50 stops the movement of the arm 30 by stopping the movement of the actuator 56.

In order to detect a collision, the collision controller 50 is in electrical communication with a current generating system 60. The current generating system 60 is coupled to a first end 62 and a second end 64 of the sleeve 40. The current generating system 60 is in communication with the collision controller 50 through signal wiring 66. The signal wiring 66 communicates a current signal to the collision controller 50 that monitors for a change in the current. During operation, the current is very small and relatively steady because of the resistance of resistor 44. A sharp increase in the current means the current has sought an alternate path. The increase is instantaneous and therefore the collision controller 50 generates a collision signal and can cease movement of the arm 30 nearly instantaneously to prevent damage to the robot. When a change in current is detected by the collision controller 50, the display 52 is activated, an audible warning is generated through the speaker 54 and the actuator 56 is stopped based on the collision signal. In some examples, only some of the above actions are taken.

The current generating system 60 includes an ammeter 70 electrically coupled to the first end 62 of the sleeve 40. The ammeter 70 is also coupled to a fuse 72 which, in turn, is coupled to a low voltage power supply 74 such as a battery. The fuse 72 is in communication with a positive terminal 76 of the low voltage power supply 74. The second end 64 of the sleeve 40 is coupled to the negate terminal 78 of the low voltage power supply 74.

A switch 80 is used to disconnect the circuit from the sleeve 40. The switch 80 is an optional feature that may be controlled by the collision controller 50.

Referring now to FIGS. 2A and 2B, the current changes when the sleeve 40 contacts an unexpected object 90 as a collision. A path 92 to the negative terminal 78 of the low voltage power supply 74 is formed through the object 90 and therefore the shorted current will increase rapidly in a rapid current change or increase 96.

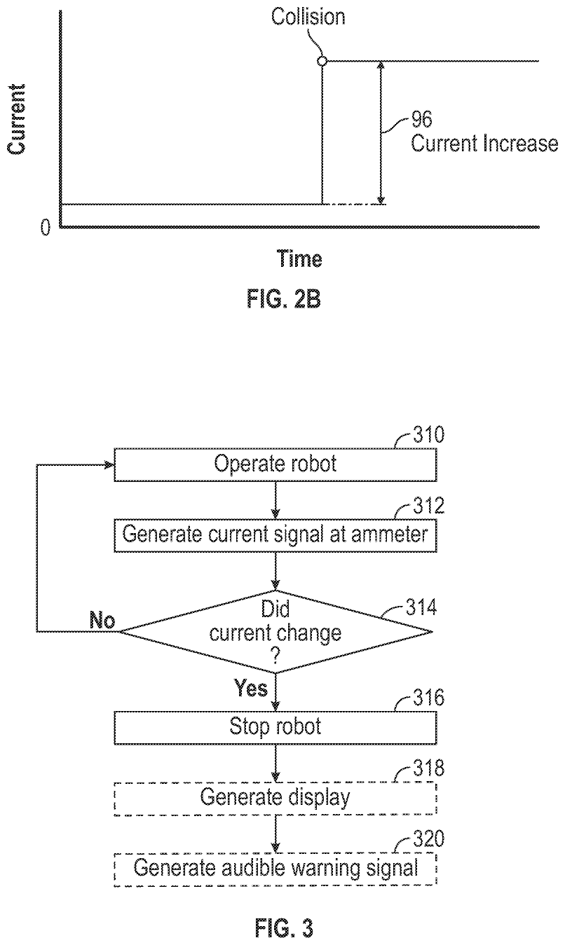

Referring now to FIG. 3, the method of monitoring for controlling a robot through detection of a current change is set forth. In this example, the robot is operated in step 310. The robot operates in a pre-programmed path. During operation, the current signal from the ammeter 70 is received through the signal wiring 66 of the collision controller 50. During normal operation (no collision) of the robot, a nearly constant current through the sleeve 40 is present. However, step 314 determines if the current has changed. Specifically, step 314 determines whether the current has increased in this example. When the current does not change, meaning no collision has occurred, step 310 is again performed. However, when the current does change in step 314, a collision signal is generated, and step 316 stops the robot from moving by controlling the actuator with a control signal based on the collision signal. Because the change is nearly instantaneous, damage is prevented at the robot. After step 316, optional steps 318 and 320 are performed. Step 318 generates a display indicative of a collision. A red light or screen display is displayed based upon the change in the current detected in step 314. Likewise, an audible warning signal is also generated as an optional in step 320. The audible warning system allows an alert to be provided to factory personnel to warn of the condition. In this manner, a remedy may be achieved. That is, a workpiece may be moved, the robot may be reprogramming or other remedies that can be performed.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A collision detection circuit for a robotic member comprising:
an electrically conductive sleeve disposed around the robotic member;
a current generating system coupled to a first end of the sleeve and a second end of the sleeve, said current generating system generating a current between the first end and the second end; and
a collision controller detecting a change in the current and stopping movement of the robotic member based on detecting the change.

2. The collision detection circuit of claim 1 wherein the current generating system comprises a power supply coupled to an ammeter and a second terminal coupled electrically coupled to the second end of the sleeve.

3. The collision detection circuit of claim 1 wherein the robotic member comprises a welding torch at the end of the robotic member.

4. The collision detection circuit of claim 1 wherein the sleeve is coupled to the robotic member at an insulator.

5. The collision detection circuit of claim 1 wherein the collision controller generates a collision signal based on a change of the current signal at an ammeter.

6. The collision detection circuit of claim 5 wherein the ammeter is electrically coupled to a positive terminal of a power supply and a negative terminal of the power supply is electrically coupled to the second end of the sleeve.

7. The collision detection circuit of claim 6 wherein the positive terminal is coupled to the ammeter through a fuse.

8. The collision detection circuit of claim 1 wherein the collision controller generates a display based on the change in the current.

9. The collision detection circuit of claim 1 wherein the collision controller generates an audible indicator based on the change in current.

10. The collision detection circuit of claim 1 wherein the collision controller controls an actuator of the robot based on the collision signal.

11. The collision detection circuit of claim 1 wherein the current generating system comprises an ammeter coupled to a sleeve disposed around a welding torch.

12. A method for collision detection for a robotic member comprising:
generating current through a conductive sleeve disposed around the robotic member, said current communicating between a first end of the sleeve and a second end of the sleeve; and
detecting a change in the current at a collision controller; and
stopping movement of the robotic member based on detecting the change.

13. The method of claim 12 wherein detecting the change comprises detecting the change using an ammeter coupled to the sleeve.

14. The method of claim 12 wherein the robotic member comprises a welding torch at the end of a robotic arm.

15. The method of claim 14 further comprising electrically coupling a positive terminal of a power supply to an ammeter and an end of the sleeve to a negative terminal of the power supply.

16. The method of claim 15 wherein coupling the positive terminal comprises coupling the positive terminal to the ammeter through a fuse.

17. The method of claim 12 further comprising generating a display based on the change in the current.

18. The method of claim 12 further comprising generating an audible indicator based on the change in current.

19. The method of claim 12 further comprising controlling an actuator of the robot based on the collision signal.

20. The method of claim 12 further comprising generating a display based on the change in the current.
